(19) United States
(12) Patent Application Publication
(10) Pub. No.: US 2011/0274600 A1
(43) Pub. Date: Nov. 10, 2011

(54) OZONE OXIDATION FILTRATION AND NEUTRALIZATION AIR CLEANING SYSTEM, APPARATUS & METHOD

(75) Inventor: Gary W. Steffens, Phillipsburg, KS (US)

(73) Assignee: Mineral Right, Inc., Phillipsburg, KS (US)

(21) Appl. No.: 13/100,623

(22) Filed: May 4, 2011

Related U.S. Application Data
(60) Provisional application No. 61/343,965, filed on May 6, 2010.

(51) Int. Cl. B01D 53/38; B01J 19/08

(52) U.S. Cl. 423/210; 422/186.1

(57) ABSTRACT

A filtration system for the reduction of air born contaminates by way of double oxidation and filtration. The primary oxidation is from a low cost method of producing cold plasma ozone. The second oxidation and primary filtration is from a catalyst (MAZ), a manganese activated zeolite. Final filtration is accomplished by a HEPA air filter. Air is drawn or blown into a cabinet by way of fan or blower with sufficient force to overcome pressure drop created by filter media.

The air stream flows through or by an ozone generator into a reaction chamber for primary oxidation of contaminates and then flows through the MAZ media for filtration by way of adsorption of contaminates and a secondary oxidation with a catalytic conversion of ozone to oxygen. The air stream then flows through a HEPA filter prior to discharge from the cabinet.

### RELATED APPLICATIONS

This application claims the benefit of co-pending U.S. Provisional Patent Application Ser. No. 61/343,965, filed 6 May 2010.

### BACKGROUND OF THE INVENTION

The present invention pertains to air filtration systems and specifically to air filtration systems for removing air borne contaminants from the atmosphere. Air borne contaminants are typically removed by use of some type of filter media. Air is passed through the filter media wherein contaminants are trapped by the filter. These types of systems are commonly found in furnaces and air conditioners. Such systems are inefficient and generally do not satisfactorily remove most contaminants from the air. The present invention is an improvement over well known air filtering technology which provides a system for efficiently and effectively removing air borne contaminants from the atmosphere, a room or other defined space.

A known way to remove air borne contaminates utilizes cold plasma ozone oxidation. However, typical cold plasma ozone production is expensive due to current means of producing a high alternating current voltage. This current is in the range of six to sixty thousand volts with low amp draw of two to twenty milliamps. The present invention provides an efficient and low cost solution in producing cold plasma ozone by using luminous gas filled or a combination of metal and gas filled glass tubes that are excited by a low cost electronic power supply.

### SUMMARY OF THE INVENTION

The present invention relates to systems, apparatus and methods for the reduction or substantial elimination of air born contaminants by way of double oxidation and filtration. The primary oxidation is from a low cost method of producing cold plasma ozone. The secondary oxidation and primary filtration is from a catalyst, such as a manganese activated zeolite (MAZ). Final filtration is accomplished by an air filter, such as a high efficiency particulate air (HEPA) filter.

The present invention includes a substantially enclosed cabinet or housing having two openings, an inlet and an outlet. Within the housing is a fan which is utilized to draw or blow contaminated atmospheric air into the housing. The fan or blower has sufficient force to overcome the pressure drop created by filter media also located within the cabinet. The fan is preferably positioned adjacent the outlet opening and the contaminated air is drawn into the housing through the air intake opening, typically located on an opposite side of the housing. After entering the housing, the contaminated air stream is passed through or by an ozone generator, such as a corona discharge ozone generator. The ozone generator oxidizes air stream in a reaction chamber whereby the oxygen (O2) is converted to ozone (O3). During this process, a substantial amount of the air borne contaminants is precipitated from the air stream. The precipitated contaminants are trapped in a first or pre-filter which is located downstream of the ozone generator.

The ozonated and oxidated air stream next passes through an oxidizing media such as a bed of manganese activated zeolite for filtration by way of adsorption of contaminates. This process also provides a secondary oxidation that converts the ozone or O3 back into oxygen (O2) through a catalytic conversion which again precipitates contaminates from the air stream. The previously generated ozone has now been substantially eliminated from the air stream.

Next, the air stream passes through a second filter. The second filter, like the first removes the remaining precipitated contaminant particulates from the air stream. Finally, the clean air passes through the fan and through the housing outlet where it is returned to the atmosphere.

### BRIEF DESCRIPTION OF THE DRAWINGS

FIG. 1 is a perspective view of the system.

FIG. 2 is a cut-away perspective view thereof.

FIG. 3 is a perspective exploded view of the compound filter assembly.

FIG. 4 is a schematic diagram of the system's electrical circuit.

### DESCRIPTION OF THE PREFERRED EMBODIMENT

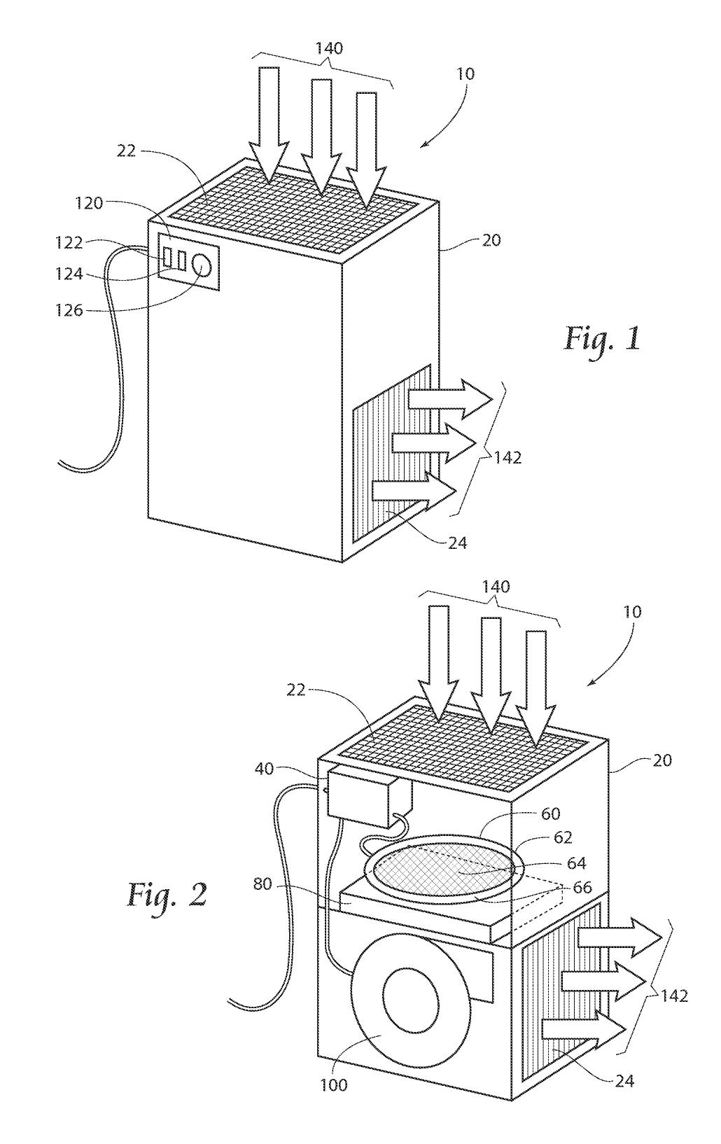

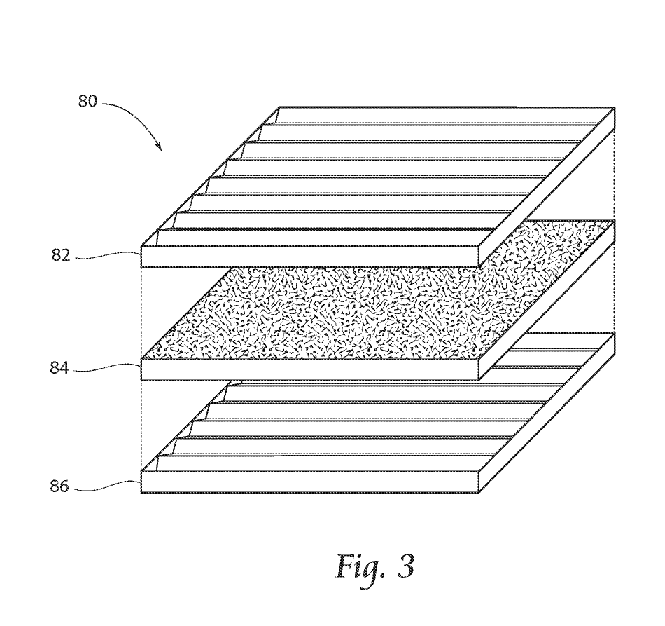

Referring to FIGS. 1 and 2, the air cleaning system is shown at reference number 10. The system includes a housing 20, an ozone generator power supply 40, an ozone generator 60, a compound filter assembly 80, a blower fan 100 and controls 120.

All of the components are housed within an enclosure 20 which defines an interior space having two openings. The openings include an intake opening 22 and an outlet opening 24. Cabinet flow configuration designs include up flow, down flow, side to side flow and/or front to rear flow.

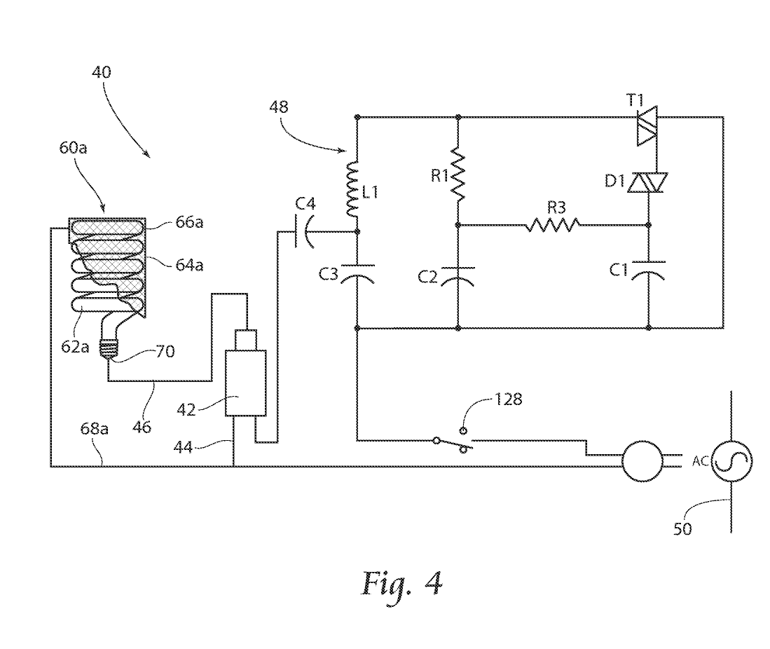

A preferred embodiment of the ozone generator power supply 40 is shown in FIG. 4. Power is supplied from a power source 50 such as a standard AC outlet. The power supply 40 includes a 60 hertz capacitor discharge ignition coil 42 with a fixed or variable current controlling circuit 48. This modulates 120 volt alternating current primary voltage that in turn controls secondary voltage output 46. In the preferred embodiment, the coil 42 has a 120 volt 1.5 amp input and a 6000 volt 0.020 amp output. The coil 42 output 46 is connected to the ozone generator 60. The end point 44 is grounded as shown.

As shown in FIGS. 2 and 4, the ozone generator power supply 40 is connected to an ozone generator 60. The positive secondary output 46 voltage is applied to the internal electrode 70 of a gas filled chamber 62 while the negative side 68 is attached to a metal electrode sheath 64 covering the glass chamber 62. Preferably, the metal electrode sheath 64 is fabricated from stainless steel. The gas filed chamber 62 can include one or more gases as follows: Helium, Neon, Argon, Krypton and/or Xenon and include one or more metals such as sodium and/or mercury.

A simple and exemplary ozone generator 60, as depicted in FIG. 2 comprises a 10 inch round fluorescent lamp 62 bonded to a stainless steel wire mesh screen 64 with silicone sealant 66 that works as an insulator. The end point ground of the ozone generator power supply 40 is attached to the screen 64. The ozone generator power supply 40 positive wire is attached to the internal electrode of the fluorescent lamp 62. The amount of ozone produced by this exemplary generator 60 could be doubled by adhering a second wire mesh screen 64 to the opposite side of the fluorescent lamp 62.

An alternative exemplary ozone generator 60a is shown in FIG. 4. This generator 60a comprises a spiral fluorescent lamp 62a bonded to wire mesh screen 64a with a silicone sealant 66a that again functions as an insulator. The end point ground 68a of the ozone generator power supply 40 is attached to the screen 64a. It is to be understood that ozone generators are commercially available and that any commercially available ozone generator could be utilized effectively in the present invention 10.

Adjacent the ozone generator 60 is a compound filter assembly 80. The first component of the compound filter 80 comprises a pre-filter 82. While any suitable filter would work, the preferred filter 82 is a high efficiency particulate air (HEPA) filter. Beneath the pre-filter 82 is a second filter 86. Again any suitable filter could be used but the preferred filter 86 is again a HEPA filter. Between the HEPA filters 82, 86 is an oxidizing media 84 such as a bed of manganese activated zeolite (MAZ).

Referring back to FIG. 2, downstream from the compound filter assembly 80 is the blower fan 100, such as a multispeed down flow furnace fan. The fan 100 draws contaminated air through the intake opening 22, across the ozone generator 60, through the compound filter assembly 80 and expels clean air back into the atmosphere through outlet opening 24. To prevent the release of concentrations of ozone due to fan or blower failure, a pressure differential switch 128 (see FIG. 4) disconnects power to the ozone generator with the loss of air movement within the cabinet or housing 20.

One or more additional controls 120 are provided on the housing 20. The controls 120 include one or more switches 122, 124 to control the distribution of electrical power to the power supply 40 and/or the fan 100. In addition, the controls 120 may include a rheostat 126 to regulate the speed at which the fan 100 operates. This, in turn, controls the amount of contaminated air that is drawn into the system 10 for treatment and the rate at which the contaminated air is exposed to the filtering media contained within the compound filter assembly 80. Air flow rate is determined by ozone production rate balanced by catalytic ozone to oxygen conversion and filter limitations. The filters 82, 86 can be flat or radial flow depending upon the surface area required. MAZ may be impregnated or coated on one or both of the filters 82, 86 or may be used as a standalone filter 84 as described above.

The system 10 works as follows. As the contaminated air stream 140 is drawn through the opening 22 and across the ozone generator 60, the contaminated air 140 is oxidized by the infusion of the ozone within a reaction chamber. The oxygen present in the contaminated air is converted from O2 to O3. This also causes a chemical reaction which precipitates contaminants from the air stream 140. These precipitated contaminant particles are trapped in the first or pre-filter 82.

A bed of oxidizing media 84 is located between the filters 82, 86. As the airstream 140 passes through the oxidizing media 84, the O3 is converted back into O2. In a preferred embodiment, the oxidizing media 84 comprises manganese activated zeolite which is basically manganese oxide or MNO2. As the ozone O3 passes through the manganese oxide MNO2, the MNO2 is converted to MNO4 (manganate ion) and the ozone O3 becomes oxygen again, O2. The previously generated ozone is substantially depleted from the air stream as its passes through the bed of oxidizing media 84. This reaction again precipitates additional contaminates from the air stream 140. These additional particles are trapped in the second filter 86. Finally, the cleaned air stream 142 passes across the fan 120 and is expelled through the outlet opening 24.

While manganese activated zeolite has been described as a suitable oxidizing media 84, it is to be understood that other oxidizing medium can be utilized including magnesium treated green sand, as well as others.

After a predetermined period of time or exposure, the filters 82, 86 and oxidizing media 84 must be cleaned or replaced.

It should also be appreciated that there are two distinct variables that can be adjusted to control the effectiveness or efficacy of the filter system 10. The first variable is the size of ozone generator 60. Depending upon the severity of the contaminated air, more or less ozone may be required to sufficiently treat the air. Secondly, the speed of the fan 100 is a variable that controls the amount of time the contaminated air is being oxidized and then converted back into oxygen. Again, a slower fan speed would result in a system having greater efficacy and capable of removing more contaminants from an air stream than a faster fan speed.

The foregoing is considered as illustrative only of the principles of the invention. Furthermore, since numerous modifications and changes will readily occur to those skilled in the art, it is not desired to limit the invention to the exact construction and operation shown and described. While the preferred embodiment has been described, the details may be changed without departing from the inventions claimed herein.

I claim:

1. A system for removing contaminates from an air stream comprising:
a housing defining an interior space and having an inlet and an outlet;
a fan for drawing the air stream into the interior space through said inlet and expelling the air stream from the interior space through said outlet;
an ozone generator located in said housing;
first and second filters located downstream of the ozone generator, the second filter comprising a zeolite oxidizing media; and
a power supply, the power supply coupled to the fan and the ozone generator.

2. The system of claim 1 wherein the ozone generator is a cold plasma ozone generator.

3. The system of claim 3 wherein the cold plasma ozone generator further comprises a luminous gas filled tube, an electrode sheath and a coil; and
the coil being coupled to an internal electrode of the gas filled tube and to the electrode sheath.

4. The system of claim 1 wherein the first filter is an air filter.

5. The system of claim 1 wherein the second filter is an air filter impregnated with the zeolite oxidizing media.

6. The system of claim 4 further including a second air filter, the second air filter located downstream of the second filter.

7. The system of claim 6 wherein the zeolite oxidizing media is impregnated on the second filter.

8. The system of claim 1 wherein the zeolite oxidizing media is selected from the group consisting of manganese activated zeolite and magnesium treated green sand.

9. The system of claim 5 wherein the zeolite oxidizing media is selected from the group consisting of manganese activated zeolite and magnesium treated green sand.

10. The system of claim 1 further including a control, said control coupled to said fan.

11. An apparatus for removing contaminates from an air stream comprising:
an enclosure having an inlet and an outlet
a fan located in the enclosure;
an ozone generator located in the enclosure;
a first filter located proximate the ozone generator;
a second filter located proximate the first filter, the second filter comprising a bed of zeolite oxidizing media;
a power supply, the power supply coupled to the fan and the ozone generator; and
whereby the air stream is drawn into the enclosure through the inlet, across the ozone generator, through the first filter, through the second filter and expelled through the outlet by the fan.

12. The apparatus of claim 11 further including a third filter located proximate the second filter.

13. The apparatus of claim 11 wherein the ozone generator is a cold plasma ozone generator.

14. The apparatus of claim 13 wherein the cold plasma ozone generator further comprises a luminous gas filled tube, an electrode sheath and a coil; and
the coil being coupled to an internal electrode of the gas filled tube and to the electrode sheath.

15. The apparatus of claim 11 wherein the second filter is an air filter impregnated with the zeolite oxidizing media.

16. The apparatus of claim 11 wherein the zeolite oxidizing media is selected from the group consisting of manganese activated zeolite and magnesium treated green sand.

17. The apparatus of claim 11 wherein the first filter is an air filter.

18. A method of removing air born contaminates from an air stream comprising the steps of:
drawing the air stream into an enclosed chamber;
oxidizing the air stream with the infusion of ozone in the chamber;
filtering the oxidized air stream with a first air filter to remove precipitated contaminants;
drawing the air stream through a bed of zeolite oxidizing media for secondary oxidation of the air stream; and
expelling the air stream from the enclosed chamber.

19. The method of claim 18 further including the step of filtering the air stream through a second air filter after oxidizing the air stream through the bed of zeolite oxidizing media.

20. The method of claim 18 wherein the zeolite oxidizing media is selected from the group consisting of selected from the group consisting of manganese activated zeolite and magnesium treated green sand.
